(19) United States
(12) Patent Application Publication
(10) Pub. No.: US 2013/0050024 A1
(43) Pub. Date: Feb. 28, 2013

(54) BISTATIC RADAR SYSTEM USING SATELLITE-BASED TRANSMITTERS WITH IONOSPHERIC COMPENSATION

(71) Applicants: William C. BAROTT, Port Orange, FL (US); Brian K. Butka, Palm Coast, FL (US); Justin D. Engle, Daytona Beach, FL (US); Albert Helfrick, DeLand, FL (US)

(72) Inventors: William C. BAROTT, Port Orange, FL (US); Brian K. Butka, Palm Coast, FL (US); Justin D. Engle, Daytona Beach, FL (US); Albert Helfrick, DeLand, FL (US)

(73) Assignee: Embry-Riddle Aeronautical University, Inc., Daytona Beach, FL (US)

(21) Appl. No.: 13/594,466

(22) Filed: Aug. 24, 2012

Related U.S. Application Data
(60) Provisional application No. 61/527,405, filed on Aug. 25, 2011.
(60) Provisional application No. 61/593,630, filed on Feb. 1, 2012.

(51) Int. Cl. G01S 3/02

(52) U.S. Cl. 342/454

(57) ABSTRACT

A system for the passive location of non-cooperating vehicles using satellite-based transmitters with ionospheric compensation. The system is a light-weight, low-cost, portable, and field-deployable station to supplement deficiencies in the National Airspace System (NAS) and homeland security surveillance networks. The system accommodates observation modes having long “integration” times that potentially are greater than one second. The system utilizes satellite-based transmitters as illuminators. The passive system measures two radio waves (e.g., a direct path and an illumination plus reflection path), and applies time-difference techniques that can compensate for the ionosphere since the ionospheric delay is applied to both signals. This also has the advantage of compensating for other uncertainties such as exist in the position of the satellite.

### CROSS-REFERENCE TO RELATED APPLICATIONS

This application claims the benefit of provisional patent application Ser. No. 61/527,405, filed on Aug. 25, 2011, and provisional patent application 61/593,630 filed on Feb. 1, 2012. The specification and drawings of the provisional patent applications are specifically incorporated by reference herein.

### TECHNICAL FIELD

Embodiments of the invention generally relate to a system for the passive monitoring of non-cooperating vehicles and, more specifically, to a system for the passive location of non-cooperating vehicles using satellite-based transmitters with compensation for ionospheric delay.

### BACKGROUND

The position and path of aircraft in the National Airspace System (NAS) has traditionally been determined by primary radars which transmit powerful radio frequency (RF) pulses to locate aircraft by “listening” for echoes. Pragmatic cost concerns have led to the development of secondary radars, which require specialized equipment on the ground and in the aircraft. When interrogated with a coded message, the aircraft system transmits encoded return pulses. Secondary radar improves the primary radar coverage and is used for a variety of other purposes including collision avoidance. The NAS is actively deploying Automatic Dependent Surveillance-Broadcast (ADS-B) surveillance technology for tracking aircraft to address the limitations of existing radar infrastructure. ADS-B is part of the Next Generation Air Transportation System and will be required for the majority of aircraft operating in the United States by the start of the next decade. ADS-B periodically broadcasts its own state vector (i.e., identification, altitude, heading, speed, position) and other information without knowing what other vehicles or entities may be receiving it. No pilot or controller action is required for the information to be issued. Surveillance information is dependent on the navigation and broadcast capability in the source ADS-B equipped aircraft.

Like current secondary radar, ADS-B requires specialized equipment onboard every aircraft in the airspace to be effective. Aircraft without ADS-B equipment must be detected by primary radars. It should be noted that incorporating the ADS-B data into an air traffic management system requires the construction of ground stations to receive the data. However, even with the addition of all planned ADS-B ground stations, there are significant gaps in the coverage of the NAS.

Passive radar is an alternative to conventional primary and secondary radar systems. Passive primary radar eliminates the cost of operating a primary radar transmitter by utilizing existing radio sources as the transmitter in the radar problem. Eliminating the transmitter means that only the relatively low-cost, portable receiver and signal processing circuitry is required to detect and monitor aircraft. Passive Coherent Location (PCL) is a passive radar system in which there is no dedicated transmitter. The receiver uses third party transmitters in the environment and measures the time difference of arrival between the signal arriving directly from the transmitter and the signal arriving via reflection from an object in order to determine the bistatic range of the object.

Passive bistatic detection alone is not a new concept. The fundamental principle of bistatic detection is to take advantage of strong signals already present in the environment, and detect their reflection from a target (i.e., aircraft). Prior research on bistatic radars has resulted in the development of several systems utilizing terrestrial-based transmitters. Existing passive bistatic radar systems utilize terrestrial transmitters and have acquisition times that are slow relative to monopulse radars (e.g., 0.1 to 1 s). One of the best known products is Silent Sentry®, a PCL system available from Lockheed Martin Corporation that uses frequency modulated (FM) radio transmissions. The Silent Sentry system uses indigenous radio and television signals to locate aircraft.

Although the Silent Sentry system does not require cooperating aircraft or illuminators, it operates at a different frequency band than embodiments of the invention and uses terrestrial illuminators. This is fundamentally different from embodiments of the invention which use satellite-based signals to locate aircraft. This difference is especially important when operating in environments where terrestrial signals are absent or compromised. There are many satellite transmitters that provide continuous signals to the entire United States. Unlike terrestrial transmitters, the satellite view of the target is not blocked by mountainous terrain and multipath issues are dramatically reduced. As compared to terrestrial transmitters, the advantages of spaceborne transmitters include a reduction in multipath and shadowing as well as a reduced reliance on vulnerable proximate infrastructure.

The ionosphere, consisting of layers of charged particles in the upper atmosphere, is known to affect radio waves and is a potentially-limiting factor in global navigation satellite systems (GNSS) like the global positioning system (GPS). It is known that it is necessary to compensate for the ever-changing delay of the ionosphere in order to achieve the best-possible accuracy with these systems. Dual-frequency systems as well as geographic augmentation systems are two such approaches to improving GPS accuracy.

The extent to which the ionosphere affects bistatic radar using satellite-based illuminators is less well-described in the literature. Bistatic radar, especially passive bistatic radar, offers advantages as compared to traditional monostatic radars. Passive bistatic radar utilizing non-cooperative spaceborne transmitters offers the potential to locate a target in three-dimensional (3D) space with greater accuracy than GPS. Given the importance of the ionosphere on GPS measurements, it is necessary to determine whether the ionosphere plays any meaningful role in passive bistatic systems.

### SUMMARY

Embodiments of the invention provide a system for the passive location of non-cooperating vehicles using satellite-based transmitters with ionospheric compensation. The embodiments include unique aspects as to the system, subsystems, algorithms, and implementation thereof. This system meets the need for passively and inexpensively monitoring non-cooperating aircraft.

In an exemplary embodiment, a method is provided for passive detection and monitoring of target vehicles with non-cooperating satellite-based transmitters. The method includes receiving a reference signal from a satellite-based transmitter at a base (e.g., ground) station along a first path and receiving a target signal at the base station reflected from a target vehicle along a second path following illumination of the target vehicle by an illuminator signal from the satellite-based transmitter. An ionospheric delay of the reference signal and the target signal in traversing the ionosphere from the satellite-based transmitter to the base station is determined. A bistatic range is determined as the time difference of arrival at the ground station between the reference signal and the target signal along the first and second paths, and any errors due to ionospheric delay of the reference and target signals. A position of the target vehicle in three-dimensional space is determined based in part on the bistatic range determination. In some embodiments, frequency difference of arrival (i.e., Doppler shift) can be used to determine bistatic velocity.

In an exemplary embodiment, a bistatic radar system is provided for passive detection and monitoring of target vehicles with non-cooperating satellite-based transmitters. The passive system includes a reference antenna for receiving a reference signal from a satellite-based transmitter along a first path and a reference receiver for amplifying the reference signal, the reference receiver implementing passive coherent location. The system further includes a target antenna for receiving a target signal reflected from a target vehicle along a second path, following illumination of the target vehicle by an illuminator signal from the satellite-based transmitter, and a target receiver for amplifying the target signal, the target receiver implementing passive coherent location for detection of target vehicles traversing an airspace, land, or a water surface. In exemplary embodiments, the bistatic radar system could be used for tracking aerial and non-aerial targets, the latter group including ground-based targets such as cars, and maritime targets such as boats, ships, etc. A plurality of analog-to-digital converters converts the amplified reference and target signals into digital signals. A control computer applies a plurality of digital signal processing algorithms to determine a bistatic range of the target vehicle and to determine a position of the target vehicle in three-dimensional space.

### BRIEF DESCRIPTION OF THE DRAWINGS

These and other advantages and aspects of the embodiments of the disclosure will become apparent and more readily appreciated from the following detailed description of the embodiments taken in conjunction with the accompanying drawings, as follows.

FIG. 1 illustrates a scenario in which a satellite-based transmitter system provides improved tracking capability over an active radar system.

FIG. 2 illustrates the geometry and characteristics of a passive bistatic radar system using non-cooperating spaceborne transmitters.

FIG. 3 illustrates the principal components of the system and the flow of information in an exemplary embodiment.

FIG. 4 illustrates software processing logic in block diagram form in an exemplary embodiment.

FIG. 5 illustrates bistatic geometry for a geostationary illuminator.

FIG. 6 illustrates bistatic geometry for a low earth-orbiting illuminator with the rays having different slant angles.

FIG. 7 illustrates right-side cumulative PDF of TEC gradients per degree of latitude taken from data in 1-hour increments with earth gridding in 1-degree steps during a calendar year.

FIG. 8 illustrates the apparent TEC gradient seen by a LEO satellite illuminator at 500 km altitude with an ionospheric height of 400 km with a static gradient of 8 TECU/deg.

### DETAILED DESCRIPTION

The following description is provided as an enabling teaching of embodiments of the invention including the best, currently known embodiment. Those skilled in the relevant art will recognize that many changes can be made to the embodiments described, while still obtaining the beneficial results. It will also be apparent that some of the desired benefits of the embodiments described can be obtained by selecting some of the features of the embodiments without utilizing other features. Accordingly, those who work in the art will recognize that many modifications and adaptations to the embodiments described are possible and may even be desirable in certain circumstances. Thus, the following description is provided as illustrative of the principles of the invention and not in limitation thereof, since the scope of the invention is defined by the claims.

The system is conceived of as a light-weight, low-cost, portable, and field-deployable station to supplement deficiencies in the National Airspace System (NAS) and homeland security surveillance networks. Potential applications include providing coverage in remote mountainous regions, low-altitude enroute primary radar coverage throughout the continental United States, and low-altitude interdiction efforts in coastal areas. As a field-deployable system, the disclosed embodiments could also be used to quickly restore primary radar coverage in the event that a disaster disables existing primary radars. Additionally, the portable and non-emitting nature of the passive radar permits a wide range of applications where emitting radars are unacceptable.

The terms “base station” and “ground station” are used throughout this description for convenience, but are not used in a limiting manner. Base station is used generically and can refer to a fixed or moving ground platform, a fixed or moving sea-based platform, or an airborne platform. The tracked targets can be airborne vehicles, land-based vehicles, or water surface-based vehicles.

A unique aspect of the disclosed embodiments is that it utilizes satellite-based transmitters as illuminators (e.g., GPS, Iridium®, XM® Satellite Radio, SIRIUS® Satellite Radio). These sources have been traditionally viewed as transmitting signals that are “too weak” for use as illuminators in monitoring systems, but these weak signals have been successfully utilized in the passive monitoring of non-cooperating vehicles as disclosed herein. A further unique attribute of the disclosed system is that it accommodates observation modes having long “integration” times, e.g., potentially greater than one second. Furthermore, another unique feature of the system is that it does not require any a priori databases of transmitters, but rather uses real-time-derived data to characterize the transmitters that are being utilized.

In systems using radio waves traveling through the earth's atmosphere, the ionosphere (i.e., upper layers of charged particles in the atmosphere) will modify the radio waves in a meaningful way, such as by slowing the speed of the radio waves. This problem is well known with GPS systems and can result in very large position errors on the order of tens of meters or more that must be corrected in order to obtain accurate positioning information. In satellite-based radar, the accuracy goal is on the order of several meters; therefore, the ionosphere must be taken into account. Otherwise, it will not be possible to identify the position of a target (e.g., aircraft) with the desired accuracy.

Embodiments for improving the positioning accuracy of a system for locating target vehicles utilizing radio waves that pass through the ionosphere include, but are not limited to, some or all of the following features: (1) incorporation of real-time ionospheric models, and (2) direct measurement of the ionosphere.

Ionospheric models are generated to help correct GPS and this data can be applied to the bistatic radar system. The ionosphere can introduce position errors of tens of meters or more. GPS implements ionospheric corrections in two ways: with dual frequency systems (historically limited to military use) and through a network of augmentation sensors and systems including Wide Area Augmentation System (WAAS), Local Area Augmentation System (LAAS), and related implementations. These systems broadcast near-real-time data on the ionosphere to the user.

A passive system that measures two radio waves (e.g., a direct path and an illumination plus reflection path), and applies a time-difference technique can compensate for the ionosphere since the ionospheric delay is applied to both signals. This also has the advantage of compensating for other uncertainties such as exist in the position of the satellite. The passive system can also measure the bistatic Doppler shift of the target signal and its direction of arrival.

Embodiments of the inventive system include, but are not limited to, some or all of the following features:

1. One or many antennas, radio receivers, and analog-to-digital-converters included as components.

2. Implementation of passive coherent location for the detection of vehicles traversing airspace, land, or water surface.

3. Use of illuminations from satellite-based transmitters in low earth orbit (LEO), medium earth orbit (MEO), and geo-stationary earth orbit (GEO) regimes.

4. Use of illuminator signals having bandwidths primarily, but not exclusively, in the several megahertz regime.

5. Use of illuminators having radio frequencies in the range between 1 GHz and 4 GHz, including, but not limited to, satellites launched for the purposes of telecommunications, satellite-radio, and navigation.

6. Incorporation of bit-minimization schemes to reduce the required digital bit-rates for signal transmission.

7. Incorporation of efficient signal drift and pulse detection to identify very weak targets having changing radar cross-section (RCS) and accelerating relative to the ground station.

8. Integration (look) times between 0.1 s and 30 s for target acquisition.

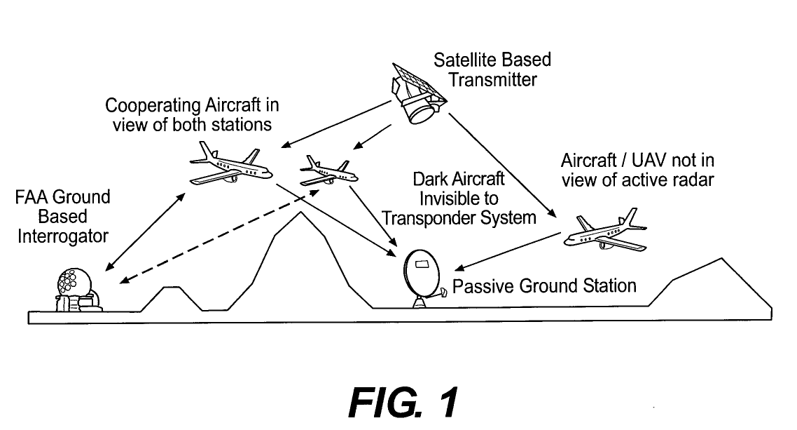

The primary application of the disclosed technology is the provision of a system that is capable of filling in the radar coverage gaps within the National Airspace System (NAS). The disclosed system is similar to primary radar in that it does not require aircraft to be equipped with specialized equipment like ADS-B, but unlike primary radar, the disclosed system does not require a transmitter at the base or ground station. FIG. 1 illustrates a scenario in which a satellite-based transmitter system provides improved tracking capability over an active radar system. Because the disclosed system is small, low-cost and entirely passive, there are no restrictions on where the system can be sited. The disclosed system can be located in remote areas far from existing radars or can be collocated with existing equipment at airports. In addition, it is very cost-effective to deploy many of the disclosed embodiments of base stations to provide both low-altitude coverage and continuous surveillance in remote and mountainous regions. It is also possible to apply the technology of the disclosed embodiments to border control radar supplementing existing border fence and aerostat radars. Because the disclosed system is unobtrusive and non-emitting, wide-scale deployment requires less real-estate, and may avoid the “not in my back yard” opposition to the location of large, powerful radars.

### Illumination Source

Known systems almost exclusively identify terrestrial-based transmitters as the illuminators for this type of work. For example, the Silent Sentry system utilizes VHF television and radio signals. The disclosed system utilizes satellite-based emitters which present two significant advantages. First, satellites cover regions of the globe that terrestrial transmitters do not (e.g., oceans, mountainous regions). Second, satellites are not as easily compromised by disaster or sabotage as are terrestrial-based transmitters.

### Frequency of Operation

Systems described in prior art patents and technical literature use radio transmissions ranging from VHF (about 100 MHz) to K-Band (about 12,000 MHz). Some satellite-based emitters operate specifically at C (4,000 MHz) and K (12,000 MHz) bands. In exemplary embodiments, the disclosed system can operate in L-band (1000-2000 MHz) and S-band (2000-4000 MHz). In other embodiments, the system could be able to operate in K-band.

### Signal Bandwidths

Different radio sources use different bandwidths which determine how accurately (or inaccurately) the position of a reflector can be determined. Known systems have bandwidths that range from about 100 KHz (e.g., cell-phone or FM Radio), to a few MHz (e.g., television), to 300 MHz (satellite television). The embodiments disclosed use transmissions having bandwidths of between 1 and (about) 10 MHz. This is a technological sweet spot that enables accurate target location without prohibitive electronics requirements.

### Method of Processing

Several aspects of data processing are common to receivers implementing passive coherent location (PCL). These include some method of filtering to remove unwanted out-of-band signals and some method of filtering to remove interfering in-band signals, and the application of a range-gated coherent detector (also called a matched filter). The disclosed system also implements such filtering techniques but with the unique aspect of utilizing specific methods to minimize the data rates in the system, thus minimizing the cost.

A second unique aspect of the disclosed system is what happens after application of a matched filter. Known systems use detection algorithms that include Doppler filtering and thresholding, and that exhibit reduced sensitivity to accelerating targets. Consequently, “look times” are limited to less than one second. The embodiments disclosed herein utilize unique algorithms that allow the detection of accelerating targets and consequently increase look-times and sensitivity (e.g., 10 s or more).

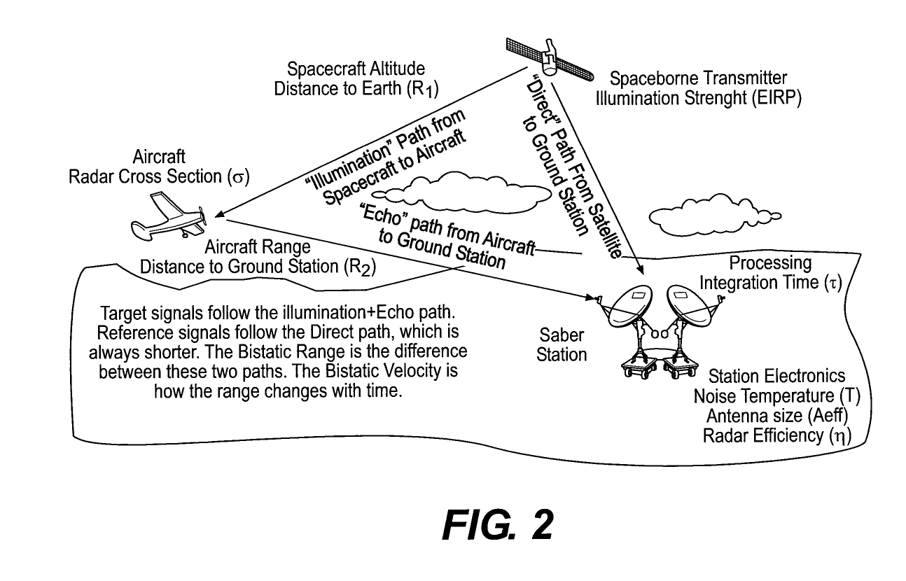

The embodiments of the system operate by time-difference-of-arrival principles as illustrated in FIG. 2. Target signals follow the path from satellite to aircraft (illumination signal) and from aircraft to base station (echo path). The base station can be either mobile or fixed. The reference signal is the direct illumination signal from satellite to base station. The bistatic range is the difference between these two paths. Velocity of the aircraft is determined from the change in bistatic range over time or by measuring the frequency difference of arrival (Doppler shift).

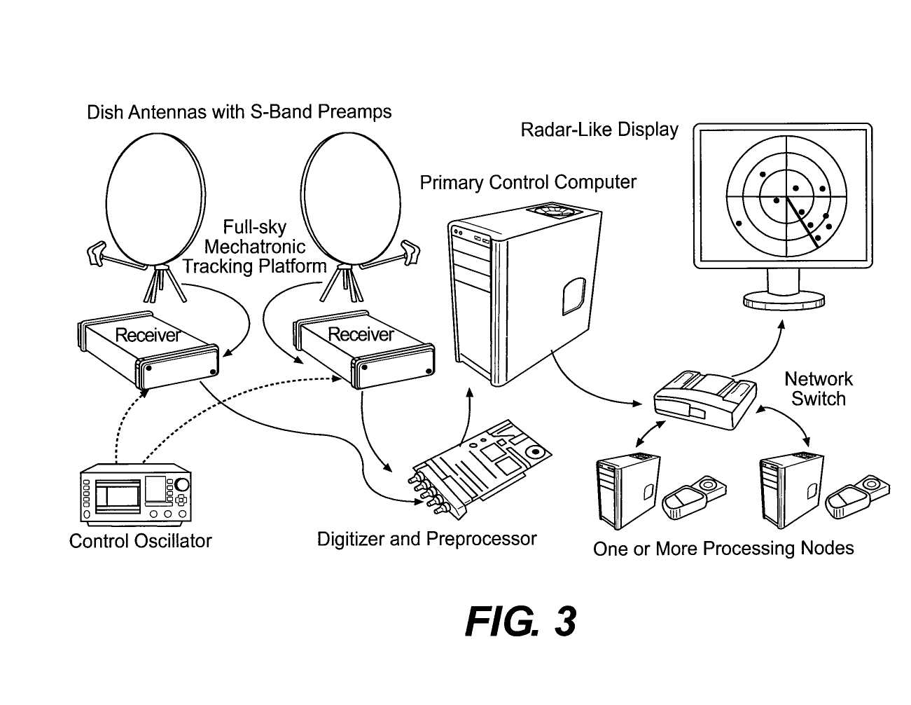

A simplified outline of the major system components of the disclosed system in an exemplary embodiment is shown in FIG. 3. In a prototype, data are conveyed to the Primary Control Computer and written to disk. Computer processing algorithms are then applied to determine whether or not a target is detected. An implementation of a final, deployed system may include fixed stations, mobile stations or devices, collectively moving platforms, and individually moving platforms in any combination, and with anywhere between one and several thousand individual antennas having any orientation. A collectively moving platform is a moving platform in which all antennas are located on the same platform. An individually moving platform is a moving platform in which one to many antennas are located on separate moving platforms. The stations and platforms forming the deployed system can be linked together to form a communications network to provide coverage in regions where there are gaps in the coverage of the NAS.

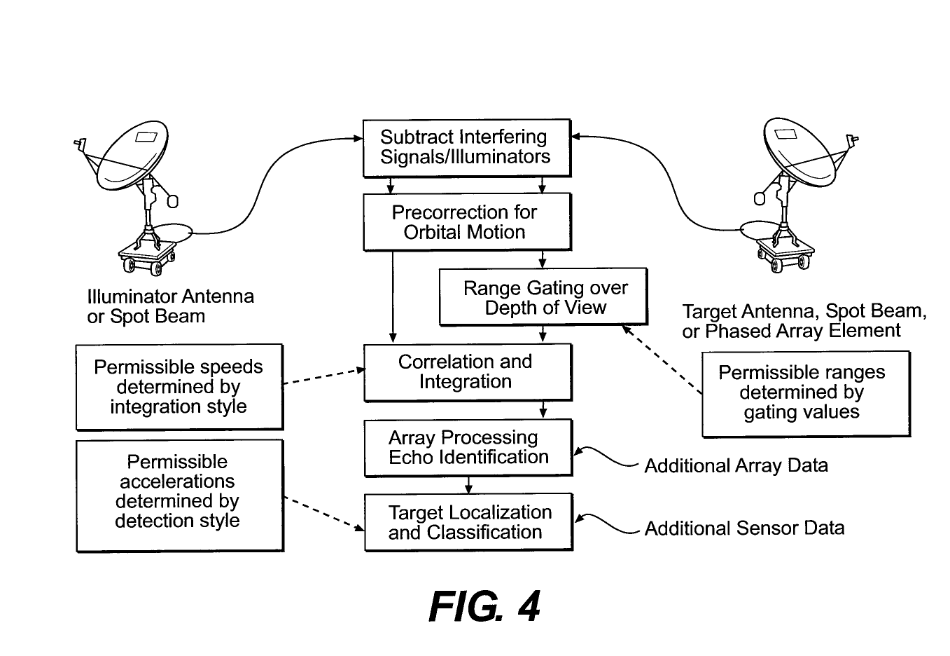

An overview of the software processing in an exemplary embodiment is depicted in FIG. 4 in block diagram form. This figure shows the major components of processing for passive radar. Phased array processing can occur both before and during the radar processing algorithm with different implications for performance and complexity.

The first processing stage suppresses interfering signals, including the illuminator, from the target data, so that the data are noise-dominated. Pre-correction compensates for the relative motion of the receiver and illuminator, and may include anticipated target characteristics. Correlation compares target and illuminator signals to determine the presence of likely echoes. Characteristics of the range gating, integration, and echo identification stages determine the allowable target ranges, speeds, and accelerations. Characteristics of the target vehicle will govern design of these stages and heavily influence computational requirements. The final stage of target localization and classification fuses data from multiple data pipelines, and can include data from multiple illuminators as well as multiple receivers.

Some technical attributes of this exemplary system include:

1. Subtraction can occur by correlation and subtraction, DSP signal processing (Weiner filtering), image “cleaning,” or phased array processing.

2. Correlation is accomplished by means of direction correlation (“X” engine), Fourier transform correlation (“FXF” engine), or overlapping FXF engines, depending on the target domain for the radar.

3. Bit minimization techniques are used to minimize data transport requirements through the stages while maintaining integrity of the signal, and can use as few as one bit to represent each sample.

4. Echo identification stages use specific algorithms to identify stationary, constant-velocity, constant acceleration, and higher-order motion targets using efficient algorithms and specific manipulation of the data sets. Algorithms include but are not limited to de-drift, de-chirp, various chirp transforms, and Doubling Accumulation Drift Detection (DADD).

An implementation of a functional system utilizing non-cooperating spaceborne transmitters and longer acquisition times is the S-band Array for Bistatic Electromagnetic Ranging (SABER), implemented in the Technology Demonstrator Array (SABER-TDA) at Embry-Riddle Aeronautical University (ERAU) in Daytona Beach, Fla. The SABER system utilizes passive radar techniques to covertly and inexpensively locate aircraft proximate to and far from the base station. SABER is unique in that it utilizes non-cooperating spaceborne transmitters as illuminators in the bistatic radar problem. In addition, SABER is implemented using a collection of commercial off the shelf (COTS) components and internal OTS components, which keeps the system costs low.

SABER is a passive bistatic radar that uses emissions from non-cooperating earth-orbiting spacecraft transmitters to detect targets such as aircraft. Key signal processing algorithms implement passive coherent location (PCL) and allow the system to use longer integration times and exhibit improved sensitivity over other systems. The SABER technology demonstrator array (SABER-TDA) was developed to verify the efficacy of this approach. It includes both hardware and software elements.

SABER-TDA utilizes the geostationary XM® Satellite Radio as the illuminator in the radar problem. SIRIUS® Satellite Radio could also be used as the illuminator. In its initial implementation, SABER was limited to a single 2 MHz downlink channel providing a coarse 150 meter resolution. Techniques utilizing wider-bandwidth signals and exploiting peak-up algorithms could provide precisions of up to 5 meters in three-dimensions. The implemented system utilizes the 2.3 GHz downlink of the geostationary XM® Radio satellites as the radar illuminator. The single 2 MHz downlink channel has a coherence length of about 150 meters and exhibits generally well-behaved ambiguity and autocorrelation characteristics. Other choices are possible worldwide. For example, the Solaris Mobile W2A satellite can be used outside of the continental U.S. (CONUS) footprint of the illuminator discussed herein. Systems based on other illuminators such as K-band Direct-Broadcast Satellite (DBS) television or the L-band Iridium® constellation may also be feasible.

### Ionosphere Delay

The ionosphere consists of layers of charged particles in the uppermost layers of the Earth's atmosphere. As an imperfect, conducting vacuum, the ionosphere affects radio signals that propagate through it. At microwave frequencies, these effects include primarily delay, attenuation, and Faraday rotation. The delay is known to be a potentially dominant source of error in global navigation satellite systems like GPS.

The ionosphere is characterized by the total electron content (TEC), which is a measure of the charge density. The delay of a signal can be expressed in meters as a function of the frequency and the TEC by the expression:

$${D}_{m} = \frac{40.3}{{f}^{2}} TEC$$

where f is the frequency in hertz (Hz) and the TEC is the electrons in a one square meter column of the atmosphere. This expression is valid for a signal traversing normal to the ionosphere, e.g., at zenith relative to a ground-based observer. In the general case, the prior equation can be modified to use the slant TEC instead. The slant TEC is given by the expression:

$${TEC}_{slant} = TEC \cdot {[ 1 - {( \frac{{R}_{e} cos ( θ )}{{R}_{e} + {H}_{i}} )}^{2} ]}^{- 0.5}$$

where Rₑ is the radius of the Earth, H, is the height of the ionosphere, and θ is the elevation angle through which the ray passes.

Values of the TEC vary significantly from day to night and over periods of solar activity, and can rapidly vary over timescales of minutes or hours. Uncertainty in the delay contributions of the ionosphere led to compensation systems in GPS. For example, dual-frequency positioning systems exploit the frequency-dependence of the signal delay equation to measure the ionospheric delay in real-time for the user. Civilian users utilize augmentation systems, such as the Wide Area Augmentation System (WAAS), to refine their position. These augmentation systems deliver representative models of the ionosphere to the user to refine the positioning to remove the effect of the ionosphere.

### Effect on Geometry

GPS utilizes ranging information to determine the distance to each satellite and ionospheric effects directly affect the ranging accuracy. For example, at 1.575 GHz, a TEC of 50 TECU produces a range error of 8.1 meters vertically, or 17.4 meters at 20 degrees elevation. Passive coherent location systems, on the other hand, are less-sensitive because they are difference-based geometries. At the XM Radio frequency (2.32 GHz), the equivalence is about 0.25 nanoseconds (ns) per TECU difference (7.5 cm) vertically. The equivalence is almost doubled to 0.51 ns per TECU difference (15.3 cm) vertically at the lower frequency of 1.62 GHz used by the low earth-orbiting (LEO) Iridium system.

As illustrated in FIG. 2, the ground station measures only the relative timing between the arrival of two radio waves, the direct and the illumination plus echo. The ionosphere affects both the direct and the illumination paths. Delay contributions that are

D_{L}=D_{G}+ΔD_{I}

I_{L}=I_{G}+ΔI_{I}

E_{L}=E_{G}

The bistatic radar measures only the difference between the direct and illumination plus echo paths, as in the bistatic range given by

R_{B}=[(I_{G}+E_{G})−D_{G}]+(ΔI_{I}−ΔD_{I})

Whereas the first set of terms represents the bistatic geometry, the latter term of the measurement represents the error due to the ionosphere. Contributions to the delay that are the same on both the illumination and the direct path will cancel each other. Since each path is lengthened by the same amount, the difference between the path lengths is unchanged, and the geometry is preserved.

Two cases of the geometry are considered herein. In the first case, it is assumed that the illuminator is very far away from the ionosphere and that the direct path and illumination rays are parallel. This case is applicable to geostationary illuminators. In the second case, it is assumed that the spacecraft is close to the ground station and that the rays are no longer parallel. This case is applicable to a low earth-orbiting (LEO) spacecraft.

### Geostationary Illuminator

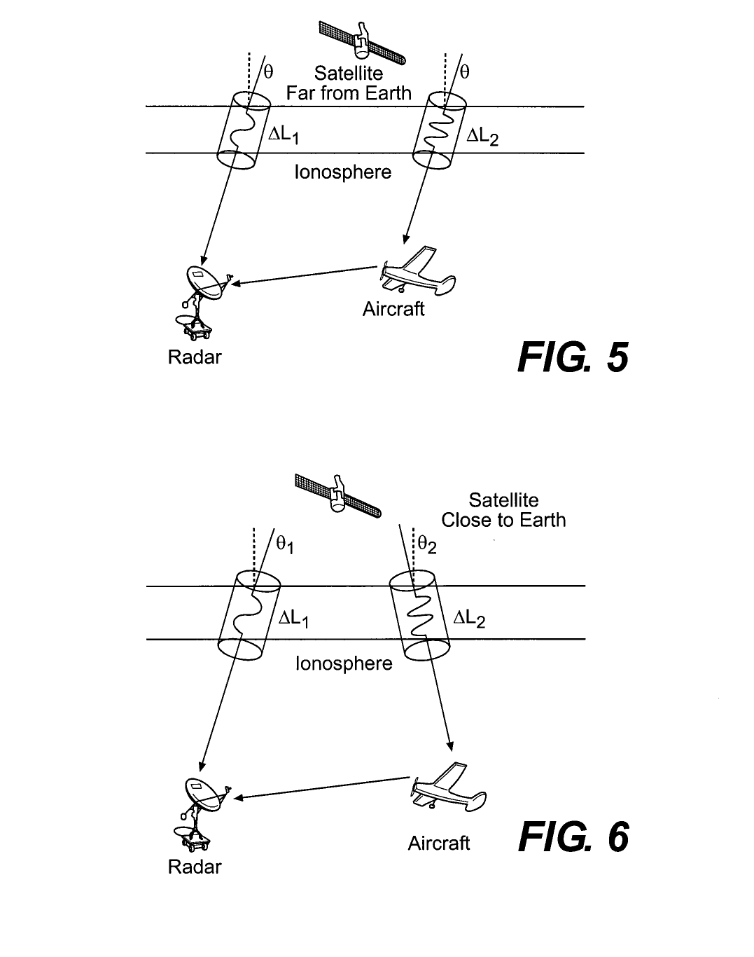

FIG. 5 contains an illustration of the geometry for the bistatic radar in the case of an illuminator that is infinitely far away from the base station and the target aircraft. The use of a geostationary illuminator is similar to this case, as the distance between the target aircraft and base station is much less than the distance between the base station and the satellite, and the target aircraft and the satellite. The illumination and direct signal generally traverse different but parallel columns of the ionosphere, as illustrated in FIG. 5. The slant of each path will be similar enough to be considered equal, although the columns are generally independent. While slants across the path will result in coupling between the paths, slants into the path will not.

### Low Earth-Orbiting Illuminator

The second case is illustrated in FIG. 6. This is the case where the illuminator is close to the earth such that the rays L1 and L2 are not sufficiently parallel. The Iridium® satellites are good examples of such an illuminator. For example, Iridium® satellites orbit at an altitude of 780 km above the surface of the Earth.

As illustrated in FIG. 6, the slant ranges are observed to be different. This is an important aspect of this geometry. While introducing a slant lengthens both paths by the same factor in case 1, the slants are effectively independent in case 2. This allows one path to lengthen while the other is constant. A benefit, however, is that under this geometry, the ionosphere traversed by the two rays becomes much closer to each other.

The anticipated effect of the ionosphere was determined by analysis of historical US-TEC data accessed from the National Geophysical Data Center archives. The US-TEC data has a geographic resolution of one degree in latitude and longitude and a temporal resolution of 15 minutes and a root mean square (RMS) accuracy of 2.4 Total Electron Content Units (TECU). Along a great circle, one degree of arc is about 111 km. This is near the anticipated limits of the SABER instrument to detect target aircraft.

### TEC Gradient for Geostationary Illuminators

The first analysis considers the difference in TEC between adjacent cells within the map. Each cell represents a one degree change in latitude or longitude. The derivative of the TEC is taken per cell to achieve a per cell differential. For derivatives along constant parallels, this figure is scaled with latitude so that the figure represents “delta TEC per 111 km” movement on the ground.

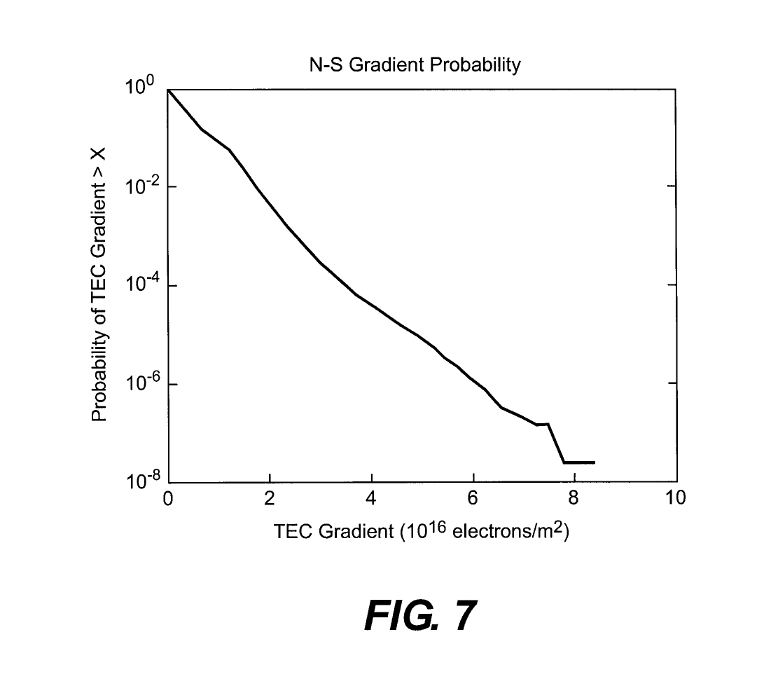

FIG. 7 contains a right-side cumulative probability density function of the TEC variation in one degree of latitude using data in one hour increments for the entire year of 2010. For each TEC gradient value, the probability that the TEC gradient is greater than or equal to the given value is plotted. For example, the probability that the TEC gradient anywhere within the data set exceeds 3.5 TECU per degree of latitude is 1.2e-4 per hour (about 1 occurrence per geographic cell per year). For XM Radio, this means that the delay error due to the ionosphere is expected to be less than 0.26 meters vertically at a rate of one occurrence per year (less than 0.52 meters at elevation angles above 20 degrees).

### TEC Gradient for Low-Earth-Orbiting Illuminators

The second analysis considers the case when the illuminator is a low-earth orbiting satellite. This model used an ionospheric height of 400 km and a hypothetical satellite at an altitude of 500 km above the surface of the earth. The ground station receiver and target are separated by one degree of arc (111 km along the surface of the earth).

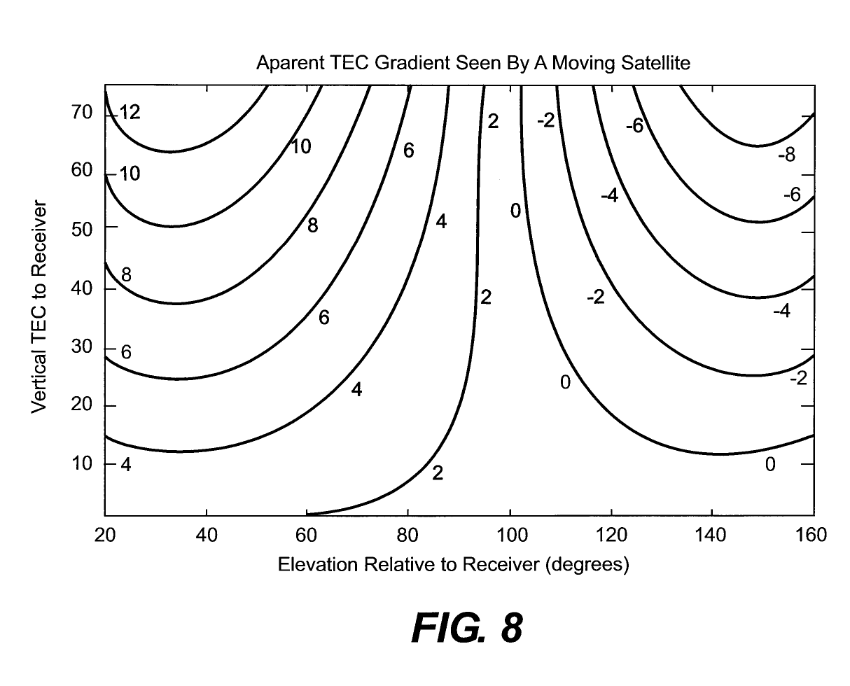

FIG. 8 contains a contour plot of the apparent TEC gradient (the TEC difference between the two paths through the ionosphere) as a function of the elevation angle of the satellite relative to the receiver and the TEC of the ionosphere. This plot is generated assuming that a static TEC gradient of 8 TECU/deg exists; however, it was found that plots are similar regardless of the static gradient. The slant difference through the ionosphere is the dominant effect in this case.

TEC values of 25-50 TECU are expected, although notable space weather events can lead to a much higher TEC. Analysis of FIG. 8 indicates an expected apparent TEC gradient of up to 10 TECU, and is consistent with the analyses with little dependence on the static TEC gradient. The apparent gradient for LEO illuminators is coincidentally similar to the maximum observed static gradient, but much more likely to be observed. For a system utilizing Iridium, path length difference errors in excess of 1.5 meters might be regularly observed, and perhaps several meters in times of high ionospheric TEC.

### Summary of Analysis of Ionospheric Effects

The analysis of the expected TEC distribution of the ionosphere has been combined with the geometry of a passive coherent location system utilizing satellite illuminators to predict the effect of the ionosphere on the accuracy of such a system. This analysis is motivated because ionospheric delay is an important factor in GPS accuracy, up to 20 meters or more. The ionosphere has large features and is slowly changing geographically compared to the expected distances between the ground station and the target aircraft in this bistatic radar and, as a result, the errors are generally small.

The expected worst-cases errors for the analyzed data set are on the order of a few meters or less (0.52 meters for XM® radio; 1.5 meters for Iridium® satellites). Reductions as compared to GPS are achieved from two factors. First, the bistatic geometry renders any consistent delay between the two paths meaningless, because the bistatic system is concerned only with the differences in the path lengths. This can be considered as the bistatic system constantly probing the ionosphere with the direct path signal. The second effect is gained in the XM® radio case from the increase in frequency. Because of the frequency dependence of the ionospheric delay, values are only 46% at XM of what they would be for the same TEC at GPS.

This analysis has determined that the contribution of the ionosphere is a meaningful, but secondary, effect to the accuracy of a passive bistatic radar system utilizing satellite-based illuminators. For coarse measurements utilizing large range cells (e.g. 150 meter granularity), the effect of the ionosphere is negligible. For more precise measurements approaching the 5 meter level, the ionosphere can contribute a large portion of the total error.

It should be noted that the error is lessened for closer range targets. For the application as a terminal area radar (e.g., 10 km), the errors will be reduced accordingly and negligible compared to the expected accuracies. Additional analysis of ionospheric data should verify the conclusions and statistically expected accuracy degradation over different periods of solar activity.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiments are possible without departing from the scope of the present invention. In addition, it is possible to use some of the features of the embodiments disclosed without the corresponding use of the other features. Accordingly, the foregoing description of the exemplary embodiments is provided for the purpose of illustrating the principles of the invention, and not in limitation thereof, since the scope of the invention is defined solely by the appended claims.

What is claimed:

1. A method for passive detection and monitoring of target vehicles with non-cooperating satellite-based transmitters, comprising:
receiving a reference signal from a satellite-based transmitter at a base station along a first path;
receiving a target signal at the base station reflected from a target vehicle along a second path following illumination of the target vehicle by an illuminator signal from the satellite-based transmitter;
determining an ionospheric delay of the reference signal and an ionospheric delay of the target signal in traversing the ionosphere from the satellite-based transmitter to the base station;
determining a bistatic range as the time difference of arrival at the base station between the reference signal and the target signal along the first and second paths, and adjusted for any errors due to ionospheric delay in receiving the reference and target signals; and
determining a position of the target vehicle in three-dimensional space based in part on the bistatic range determination.

2. The method for passive detection and monitoring of claim 1 further comprising determining a velocity of the target vehicle based on a change in the bistatic range over a period of time.

3. The method for passive detection and monitoring of claim 1 further comprising determining a velocity of the target vehicle based on a bistatic Doppler shift associated with the target vehicle.

4. The method for passive detection and monitoring of claim 1 further comprising suppressing interfering signals including the illuminator signal from the target signals by subtracting the interfering signals from the target signals.

5. The method for passive detection and monitoring of claim 4 wherein subtracting the interfering signals comprises at least one of correlation and subtraction, digital signal processing, image cleaning, and phased-array processing.

6. The method for passive detection and monitoring of claim 5 wherein correlation comprises at least one of a direct correlation, a Fourier transform correlation, or an overlapping Fourier transform correlation depending on a frequency domain for the target signals.

7. The method for passive detection and monitoring of claim 6 further comprising identifying target echoes as representing one of a stationary target, a constant-velocity target, a constant acceleration target, and a higher-order motion target using at least one of a de-drift algorithm, a de-chirping algorithm, a chirp transform algorithm, and a doubling accumulation drift detection algorithm.

8. The method for passive detection and monitoring of claim 1 further comprising filtering the received signals to remove out-of-band signals and interfering in-band signals.

9. The method for passive detection and monitoring of claim 1 wherein the satellite-based transmitter operates in at least one of L-band and S-band.

10. The method for passive detection and monitoring of claim 9 wherein the L-band operational range is about from 1.0 GHz to about to 2.0 Ghz.

11. The method for passive detection and monitoring of claim 9 wherein the S-band operational range is about from 2.0 GHz to about to 4.0 GHz.

12. The method for passive detection and monitoring of claim 1 further comprising applying a pre-correction algorithm to the received signals to compensate for a relative motion of the base station receiver and illuminator.

13. The method for passive detection and monitoring of claim 1 further comprising applying a range-gated coherent detector to the received signals at the base station.

14. The method for passive detection and monitoring of claim 1 further comprising applying a compensation algorithm to adjust for any errors caused by the delay of the reference signal and the delay of the target signal in traversing the ionosphere from the satellite-based transmitter to the base station.

15. The method for passive detection and monitoring of claim 14 wherein the delay of each signal from the satellite-based transmitter is a function of frequency and a slant total electronic content (TEC) in a column of the atmosphere.

16. The method for passive detection and monitoring of claim 14 wherein the satellite-based transmitter comprises a geostationary illuminator.

17. The method for passive detection and monitoring of claim 14 wherein the satellite-based transmitter comprises a low earth-orbiting illuminator.

18. The method for passive detection and monitoring of claim 11 wherein the base station is mobile.

19. The method for passive detection and monitoring of claim 1 wherein the target vehicle is at least one of an airborne vehicle, a land-based vehicle, or a water-based vehicle.

20. A method for passive detection and monitoring of target vehicles with non-cooperating satellite-based transmitters, comprising:
receiving a reference signal from a satellite-based transmitter at a base station along a first path;
receiving an associated target signal at the base station reflected from a target vehicle along a second path following illumination of the target vehicle by an illuminator signal from the satellite-based transmitter;
determining a bistatic range as the time difference of arrival at the base station between the reference signal and the associated target signal along the first and second paths;
applying a compensation factor to the bistatic range determination to adjust for any error caused by ionospheric traversal of the received signals;
determining a bistatic velocity as the frequency difference of arrival at the base station between the reference signal and the associated target signal along the first and second paths; and
determining a state vector of the target vehicle during a period of time during which the target vehicle is being monitored.

21. The method for passive detection and monitoring of claim 20 wherein determining a state vector of the target vehicle comprises determining a change in the bistatic range during a period of time during which a plurality of reference signals and a plurality of associated target signals are received.

22. The method for passive detection and monitoring of claim 21 wherein the state vector includes a position, velocity, and acceleration of the target vehicle.

23. The method for passive detection and monitoring of claim 20 wherein the satellite-based transmitter is a geostationary illuminator and the reference signal and illuminator signal are relatively parallel to each other so that the delays of the reference signal and the associated target signal in traversing the ionosphere results in a negligible time difference of arrival at the base station.

24. The method for passive detection and monitoring of claim 20 wherein the satellite-based transmitter is a low earth-orbiting illuminator and the reference signal and illuminator signal are not sufficiently parallel to each other so that the delays of the reference signal and the associated target signal in traversing the ionosphere results in a significant time difference of arrival at the base station requiring applying the compensation factor.

25. The method for passive detection and monitoring of claim 20 wherein the compensation factor represents a delay of the reference signal and a delay of the target signal in traversing the ionosphere from the satellite-based transmitter to the base station.

26. The method for passive detection and monitoring of claim 25 wherein the delay of each signal from the satellite-based transmitter is a function of frequency and a slant total electronic content (TEC) in a column of the atmosphere.

27. The method for passive detection and monitoring of claim 25 wherein the determination of bistatic range is adjusted based on incorporation of data from a real-time ionospheric model stored in an associated database.

28. A bistatic radar system for passive detection and monitoring of target vehicles with non-cooperating satellite-based transmitters, comprising:
a reference antenna for receiving a reference signal from a satellite-based transmitter along a first path;
a reference receiver for amplifying the reference signal, the reference receiver implementing passive coherent location;
a target antenna for receiving a target signal reflected from a target vehicle along a second path following illumination of the target vehicle by an illuminator signal from the satellite-based transmitter;
a target receiver for amplifying the target signal, the target receiver implementing passive coherent location for detection of target vehicles traversing an airspace, land, or a water surface;
a plurality of analog-to-digital converters for converting the amplified reference and target signals into digital signals; and
a control computer for applying a plurality of digital signal processing algorithms to determine a bistatic range and a bistatic velocity of the target vehicle and to determine a position of the target vehicle in three-dimensional space.

29. The bistatic radar system for passive detection and monitoring of claim 28 wherein the bistatic range is the time difference of arrival between the reference signal along the first path at the reference receiver and the target signal along the second path at the target receiver, and adjusted for any errors due to ionospheric delay in receiving the reference and target signals.

30. The bistatic radar system for passive detection and monitoring of claim 28 wherein the bistatic velocity is the frequency difference of arrival between the reference signal along the first path at the reference receiver and the target signal along the second path at the target receiver.

31. The bistatic radar system for passive detection and monitoring of claim 28 wherein a digital signal processing algorithm uses bit minimization techniques to minimize data transport requirements through a plurality of processing stages while maintaining integrity of the signal being processed.

32. The bistatic radar system for passive detection and monitoring of claim 31 wherein the processing stages comprise an interfering signal suppression stage, a correlation stage, a range gating stage, an integration stage, and an echo identification stage.

33. The bistatic radar system for passive detection and monitoring of claim 32 wherein the correlation stage compares target and illuminator signals to determine a presence of echo signals.

34. The bistatic radar system for passive detection and monitoring of claim 32 wherein the range-gating, integration, and echo identification stages determines allowable target ranges, speeds, and accelerations.

35. The bistatic radar system for passive detection and monitoring of claim 32 wherein the integration stage uses integration times greater than one second for target acquisition.

36. The bistatic radar system for passive detection and monitoring of claim 32 wherein the integration stage uses integration times between 0.1 second and 30 seconds for target acquisition.

37. The bistatic radar system for passive detection and monitoring of claim 28 wherein a digital signal processing algorithm identifies stationary, constant-velocity, constant acceleration, and higher-order motion targets.

38. The bistatic radar system for passive detection and monitoring of claim 28 wherein the bistatic radar system is deployed at a fixed base station.

39. The bistatic radar system for passive detection and monitoring of claim 28 wherein the bistatic radar system is deployed on a mobile platform.

40. The bistatic radar system for passive detection and monitoring of claim 39 wherein the mobile platform is a collectively moving platform having all antennas of the system on the same platform.

41. The bistatic radar system for passive detection and monitoring of claim 39 wherein the mobile platform is an individually moving platform having at least one antenna located on a separate moving platform.

42. The bistatic radar system for passive detection and monitoring of claim 28 wherein the satellite-based transmitter operates in at least one of L-band and S-band.

43. The bistatic radar system for passive detection and monitoring of claim 42 wherein the L-band operational range is about from 1.0 GHz to about to 2.0 Ghz.

44. The bistatic radar system for passive detection and monitoring of claim 42 wherein the S-band operational range is about from 2.0 GHz to about to 4.0 GHz.

45. The bistatic radar system for passive detection and monitoring of claim 28 wherein the target vehicle is at least one of an airborne vehicle, a land-based vehicle, or a water-based vehicle.

46. The bistatic radar system for passive detection and monitoring of claim 28 wherein the satellite-based transmitter is characterized by real-time data derived from the processed reference and target signals.

47. The bistatic radar system for passive detection and monitoring of claim 28 wherein the satellite-based transmitter is an XM® or SIRIUS® satellite radio.

48. The bistatic radar system for passive detection and monitoring of claim 28 wherein the satellite-based transmitter is a Global Positioning System (GPS) satellite.

49. The bistatic radar system for passive detection and monitoring of claim 28 wherein the satellite-based transmitter is an Iridium® satellite.

50. The bistatic radar system for passive detection and monitoring of claim 28 wherein the digital signal processing algorithms comprise a compensation algorithm for applying a bistatic range adjustment for any errors caused by the delay of the reference signal and the delay of the target signal in traversing the ionosphere from the satellite-based transmitter to the base station.

51. A field-deployable system for passive detection and monitoring of target vehicles with non-cooperating satellite-based transmitters, comprising:
a plurality of bistatic radar systems comprising a plurality of antennas and receivers deployed throughout a geographical region and linked to form a communications network, each bistatic radar system including:
a reference antenna for receiving a reference signal from a satellite-based transmitter along a first path;
a reference receiver for amplifying the reference signal, the reference receiver implementing passive coherent location;
a target antenna for receiving a target signal reflected from a target vehicle along a second path following illumination of the target vehicle by an illuminator signal from the satellite-based transmitter;
a target receiver for amplifying the target signal, the target receiver implementing passive coherent location for detection of target vehicles traversing an airspace, land, or a water surface;
a plurality of analog-to-digital converters for converting the amplified reference and target signals into digital signals; and
a control computer for applying a plurality of digital signal processing algorithms to determine a bistatic range and a bistatic velocity of the target vehicle and to determine a position of the target vehicle in three-dimensional space.

52. The field-deployable system for passive detection and monitoring of claim 50 wherein the bistatic range is the time difference of arrival between the reference signal along the first path at the reference receiver and the target signal along the second path at the target receiver, and adjusted for any errors due to ionospheric delay in receiving the reference and target signals.

53. The field-deployable system for passive detection and monitoring of claim 50 wherein the bistatic velocity is the frequency difference of arrival between the reference signal along the first path at the reference receiver and the target signal along the second path at the target receiver.

54. The field-deployable system for passive detection and monitoring of claim 50 wherein the plurality of bistatic radar systems comprises at least one of a plurality of fixed stations, a plurality of mobile stations, a plurality of collectively moving platforms, and a plurality of individually moving platforms.

55. The field-deployable system for passive detection and monitoring of claim 50 wherein the plurality of antennas comprises a plurality of individual antennas having any orientation.
